(19) United States
(12) Patent Application Publication
(10) Pub. No.: US 2006/0097638 A1
(43) Pub. Date: May 11, 2006

(54) Plasma display panel

(76) Inventors: Seung-Hyun Son, Suwon-si (KR); Hidekazu Hatanaka, Suwon-si (KR); Young-Mo Kim, Suwon-si (KR); Ho-Nyeon Lee, Suwon-si (KR); Sang-Hun Jang, Suwon-si (KR); Seong-Eui Lee, Suwon-si (KR); Hyoung-Bin Park, Suwon-si (KR); Gi-Young Kim, Suwon-si (KR)

Correspondence Address: Robert E. Bushnell, Suite 300, 1522 K Street, N.W., Washington, DC, 20005, US

(21) Appl. No.: 11/268,478

(22) Filed: Nov. 8, 2005

(30) Foreign Application Priority Data
Nov. 8, 2004 (KR) 10-2004-0090493

(51) Int. Cl. H01J 17/49

(52) U.S. Cl. 313/584

(57) ABSTRACT

A plasma display panel includes: a lower substrate and an upper substrate facing each other, spaced apart by a predetermined gap, and forming a discharge space therebetween; barriers provided between the lower substrate and the upper substrate, the barriers being formed by dividing the discharge space so as to define a plurality of discharge cells; address electrodes formed on the lower substrate; a first dielectric layer covering the address electrodes; a phosphor layer formed on an internal wall of each of the discharge cells; first and second sustaining electrodes formed in pairs on the upper substrate in each of the discharge cells; and first and second auxiliary electrodes which are formed on the upper substrate so as to correspond to the first and second sustaining electrodes, and in which predetermined voltages are induced as external voltages are applied the first and second sustaining electrodes. The first and second auxiliary electrodes are made of a resistive material.

### CLAIM OF PRIORITY

This application makes reference to, incorporates the same herein, and claims all benefits accruing under 35 U.S.C. §119 from an application for PLASMA DISPLAY PANEL earlier filled in the Korean Intellectual Property Office on 8 Nov. 2004 and there duly assigned Serial No. 10-2004-0090493.

### BACKGROUND OF THE INVENTION

1. Technical Field

The present invention relates to a plasma display panel (PDP), and more particularly, to a PDP which can reduce a discharge voltage while improving luminous efficiency.

2. Description of the Related Art

A plasma display panel (PDP) is an image forming apparatus using electrical discharge, and has gradually gained popularity due to its excellent display characteristics, including high brightness and a wide angle of view. In such PDPs, as a direct current (DC) or an alternating current (AC) voltage is applied to electrodes, a gas discharge occurs between the electrodes, and phosphors are excited by ultraviolet (UV) light generated in the course of the gas discharge, thereby emitting visible light.

The PDP can be classified into a DC type PDP and an AC type PDP according to the discharge type. The DC type PDP is constructed in such a manner that all electrodes are exposed to a discharge space and operations are performed in a state of direct-current discharge occurring between corresponding electrodes. On the other hand, the AC type PDP is constructed so that at least one electrode is covered by a dielectric layer and operations are performed by wall charge rather than by direct migration of charge.

In addition, the PDP can be classified as a facing discharge type PDP and a surface discharge type PDP according to the arrangement of the electrodes. In the facing discharge type PDP, in which sustaining electrodes are paired on an upper substrate and a lower substrate, respectively, discharge occurs in a direction perpendicular to the substrates. In the surface discharge type PDP, sustaining electrodes are arranged in pairs on a single substrate, and discharge occurs in a direction parallel to the substrate.

In spite of high luminous efficiency, the facing discharge type PDP is liable to deterioration in the phosphor layer due to plasma. Thus, in recent years, the surface discharge type PDP has become the main type of display device.

In the PDP, the luminous efficiency can be enhanced by increasing a partial pressure of the Xe gas, which may, however, undesirably increase discharge voltage. The luminous efficiency of the PDP can also be enhanced by extending the discharge path by increasing the distance between each of the sustaining electrodes. In this case, an increase in discharge voltage is also unavoidable.

### SUMMARY OF THE INVENTION

The present invention provides a plasma display panel which reduces a discharge voltage while improving luminous efficiency.

According to an aspect of the present invention, a plasma display panel includes: a lower substrate and an upper substrate facing each other, spaced apart by a predetermined gap, and forming a discharge space therebetween; barriers provided between the lower substrate and the upper substrate, the barriers being formed by dividing the discharge space so as to define a plurality of discharge cells; address electrodes formed on the lower substrate; a first dielectric layer covering the address electrodes; a phosphor layer formed on an internal wall of each of the discharge cells; first and second sustaining electrodes formed in pairs on the upper substrate in each of the discharge cells; and first and second auxiliary electrodes formed on the upper substrate so as to correspond to the first and second sustaining electrodes, and in which predetermined voltages are induced as external voltages are applied to the first and second sustaining electrodes. The first and second auxiliary electrodes are made of a resistive material.

According to another aspect of the present invention, a plasma display panel includes: a lower substrate and an upper substrate facing each other, spaced apart by a predetermined gap, and forming a discharge space therebetween; barriers provided between the lower substrate and the upper substrate, the barriers being formed by dividing the discharge space so as to define a plurality of discharge cells; address electrodes formed on either the lower substrate or the upper substrate; a first dielectric layer covering the address electrodes; a phosphor layer formed on an internal wall of each of the discharge cells; first and second sustaining electrodes formed in pairs on the lower substrate in each of the discharge cells; and first and second auxiliary electrodes formed on the lower substrate so as to correspond to the first and second sustaining electrodes, and in which voltages are induced as the voltages are applied to the first and second sustaining electrodes. The first and second auxiliary electrodes are made of a resistive material.

According to still another aspect of the present invention, a plasma display panel includes: a lower substrate and an upper substrate facing each other, spaced apart by a predetermined gap, and forming a discharge space therebetween; barriers provided between the lower substrate and the upper substrate, the barriers being formed by dividing the discharge space so as to define a plurality of discharge cells; address electrodes formed on the lower substrate; a first dielectric layer covering the address electrodes; a phosphor layer formed on an internal wall of each of the discharge cells; first and second sustaining electrodes formed in pairs on the upper substrate in each of the discharge cells; and an auxiliary electrode formed on the upper substrate so as to correspond to the first sustaining electrode, and in which a voltage is induced as the voltage is applied to the first sustaining electrode.

According to yet another aspect of the present invention, a plasma display panel includes: a lower substrate and an upper substrate spaced apart by a predetermined interval, and facing each other with a discharge space formed therebetween; barriers provided between the lower substrate and the upper substrate, the barriers being formed by dividing the discharge space so as to define a plurality of discharge cells; address electrodes formed on the lower substrate; a first dielectric layer covering the address electrodes; a phosphor layer formed on an internal wall of each of the discharge cells; first and second sustaining electrodes formed in pairs on the lower substrate in each of the discharge cells; and an auxiliary electrode formed on the lower substrate so as to correspond to the first sustaining electrode, and in which a voltage is induced as an external voltage is applied to the first sustaining electrode.

According to a further aspect of the present invention, a plasma display panel includes: a lower substrate and an upper substrate spaced apart by a predetermined interval and facing each other with a discharge space formed therebetween; barriers provided between the lower substrate and the upper substrate, the barriers being formed by dividing the discharge space so as to define a plurality of discharge cells; address electrodes formed on the lower substrate; a first dielectric layer covering the address electrodes; a phosphor layer formed on an internal wall of each of the discharge cells; first and second sustaining electrodes formed in pairs on the upper substrate in each of the discharge cells; first and second auxiliary electrodes formed on the upper substrate so as to correspond to the first and second sustaining electrodes, and in which voltages are induced as external voltages are applied to the first and second sustaining electrodes; and third and fourth auxiliary electrodes which are paired between the lower and upper substrates so as to be opposite to and facing each other, and which are electrically connected to the first and second auxiliary electrodes, respectively.

According to another aspect of the present invention, a plasma display panel includes: a lower substrate and an upper substrate spaced apart by a predetermined interval and facing each other with a discharge space formed therebetween; barriers provided between the lower substrate and the upper substrate, the barriers being formed by dividing the discharge space so as to define a plurality of discharge cells; address electrodes formed on either the lower substrate or the upper substrate; a first dielectric layer covering the address electrodes; a phosphor layer formed on an internal wall of each of the discharge cells; first and second sustaining electrodes formed in pairs on the lower substrate in each of the discharge cells; first and second auxiliary electrodes formed on the lower substrate so as to correspond to the first and second sustaining electrodes, and in which voltages are induced as external voltages are applied to the first and second sustaining electrodes; and third and fourth auxiliary electrodes which are paired between the lower and upper substrates so as to be opposite to and facing each other, and which are electrically connected to the first and second auxiliary electrodes, respectively.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is an exploded perspective view of a PDP;

FIGS. 2A and 2B are cross-sectional views taken along horizontal and vertical directions of the PDP shown in FIG. 1;

FIGS. 3A and 3B are cross-sectional views taken along horizontal and vertical directions of a PDP according to a first embodiment of the present invention;

FIG. 4 is a cross-sectional view illustrating a variation of the PDP according to the first embodiment of the present invention;

FIGS. 5A and 5B are cross-sectional views taken along horizontal and vertical directions of a PDP according to a second embodiment of the present invention;

FIGS. 6A and 6B are cross-sectional views taken along horizontal and vertical directions of a PDP according to a third embodiment of the present invention;

FIGS. 7A and 7B are cross-sectional views taken along horizontal and vertical directions of a PDP according to a fourth embodiment of the present invention;

FIGS. 8A and 8B are cross-sectional views taken along horizontal and vertical directions of a PDP according to a fifth embodiment of the present invention; and

FIGS. 9A and 9B are cross-sectional views taken along horizontal and vertical directions of a PDP according to a sixth embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or similar parts.

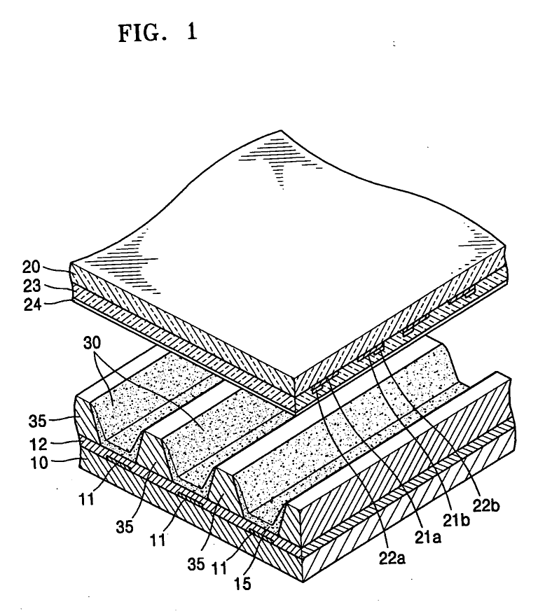

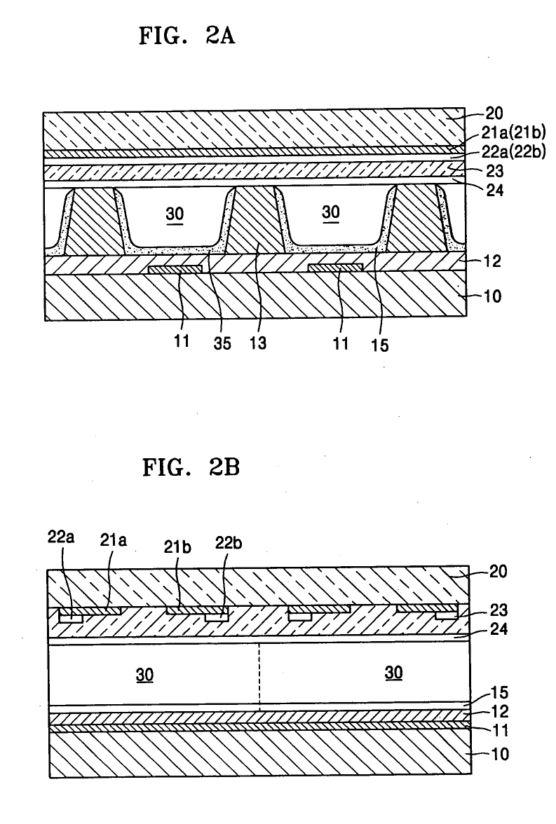

FIG. 1 is an exploded perspective view of a PDP, and FIGS. 2A and 2B are cross-sectional views taken along horizontal and vertical directions of the PDP shown in FIG. 1.

Referring to FIGS. 1, 2A and 2B, the PDP includes a lower substrate 10 and an upper substrate 20 spaced apart by a predetermined interval and facing each other with the predetermined interval therebetween. The space between the lower substrate 10 and the upper substrate 20 is a discharge space in which a plasma discharge occurs.

Multiple address electrodes 11 are formed on the lower substrate 10, and the address electrodes 11 are covered by a first dielectric layer 12. The discharge space is divided into discharge cells 30 on the first dielectric layer 12. Multiple barriers 35 for preventing electrical/optical interference between each of the discharge cells 30 are spaced apart by a predetermined gap. The discharge cells 30 are filled with a discharge gas, generally an inert gas mixture of neon (Ne) and xenon (Xe). A phosphor layer 15 is coated to a predetermined thickness on the top surface of the first dielectric layer 12 and lateral surfaces of the barriers 35, forming internal walls of the discharge cells 30.

The upper substrate 20 is a transparent substrate through which visible light can be transmitted, and is usually made of glass. The upper substrate 20 is combined with the lower substrate 10 having the barriers 35. Sustaining electrodes 21a and 21b, orthogonal to the address electrodes 11, are formed in pairs on the bottom surface of the upper substrate 20. The sustaining electrodes 21a and 21b are typically made of a transparent conductive material, e.g., indium tin oxide (ITO), so as to transmit visible light. In order to reduce line resistance of the sustaining electrodes 21a and 21b, bus electrodes 22a and 22b made of a metallic material are formed on the bottom surfaces of the sustaining electrodes 21a and 21b, respectively, so as to be narrower than the sustaining electrodes 21a and 21b, respectively. The sustaining electrodes 21a and 21b and the bus electrodes 22a and 22b are covered by a transparent second dielectric layer 23. A protective layer 24 is formed on the bottom surface of the second dielectric layer 23. The protective layer 24 prevents the second dielectric layer 23 from being damaged due to sputtering of plasma particles, and reduces discharge voltage by emitting secondary electrons. The protective layer 24 is generally made of magnesium oxide (MgO).

In the aforementioned PDP, the luminous efficiency can be enhanced by increasing a partial pressure of the Xe gas, which may, however, undesirably increase discharge voltage. The luminous efficiency of the PDP can also be enhanced by extending the discharge path by increasing the distance between the sustaining electrodes 21a and 21b. In this case, an increase in the discharge voltage is also unavoidable.

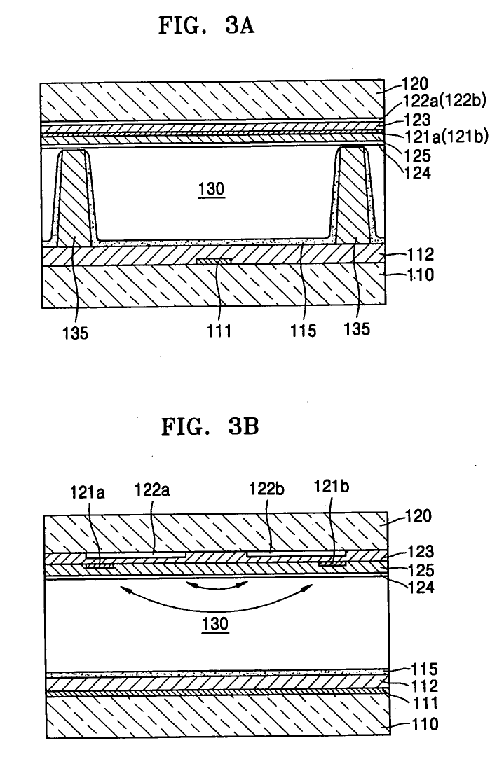

FIGS. 3A and 3B are cross-sectional views taken along horizontal and vertical directions of a PDP according to a first embodiment of the present invention.

The PDP of FIGS. 3A and 3B is a reflective PDP, and is constructed in such a manner that a lower substrate 110 and an upper substrate 120 face each other with a discharge space formed therebetween. The lower substrate 110 and the upper substrate 120 are generally made of glass.

Multiple address electrodes 111 are formed on the lower substrate 110, and the address electrodes 111 are covered by a first dielectric layer 112. The discharge space is divided into multiple discharge cells 130 on the first dielectric layer 112, and multiple barriers 135 are spaced apart from each other by a predetermined gap, and are formed parallel to the address electrodes 111. The barriers 135 prevent electrical/optical interference between adjacent discharge cells 130. The discharge cells 130 are filled with a discharge gas emitting UV light by plasma discharge. A phosphor layer 115 is excited by the UV light so as to emit visible light, and is coated on the top surface of the first dielectric layer 112 and lateral surfaces of the barriers 135, forming internal walls of the discharge cells 130 to a predetermined thickness.

Although not shown in FIGS. 3A and 3B, a reflective layer for reflecting the visible light emitted from the discharge cells 130 toward the upper substrate 120 is formed on the lower substrate 110.

First and second auxiliary electrodes 122a and 122b, respectively, are paired on the bottom surface of the upper substrate 120 in each of the discharge cells 130. The first and second auxiliary electrodes 122a and 122b, respectively, are covered by a second dielectric layer 123. The first and second auxiliary electrodes 122a and 122b, respectively, are formed in a direction orthogonal to the address electrodes 111. In addition, first and second sustaining electrodes 121a and 121b, respectively, are paired on the bottom surface of the second dielectric layer 123 in each of the discharge cells 130. The first and second sustaining electrodes 121a and 121b, respectively, are covered by a third dielectric layer 125. The first and second sustaining electrodes 121a and 121b, respectively, are formed in a direction orthogonal to the address electrodes 111.

The first and second sustaining electrodes 121a and 121b, respectively, are electrodes to which external voltages are applied. The first sustaining electrode 121a is an X electrode functioning as a display electrode while the second sustaining electrode 121b is a Y electrode functioning as a scanning electrode. The first and second sustaining electrodes 121a and 121b, respectively, are generally made of a non-resistive metallic material such as Ag.

The first and second auxiliary electrodes 122a and 122b, respectively, are formed so as to correspond to the first and second sustaining electrodes 121a and 121b, respectively, and are floating electrodes to which voltages are applied as external voltages induced in the first and second sustaining electrodes 121a and 121b, respectively. That is to say, if external voltages are applied to the first and second sustaining electrodes 121a and 121b, respectively, predetermined voltages lower than the voltages applied to the first and second sustaining electrodes 121a and 121b, respectively, due to a voltage drop caused by the second dielectric layer 123 are induced in the first and second auxiliary electrodes 122a and 122b, respectively. The voltage induced in the first and second auxiliary electrodes 122a and 122b, respectively, can be adjusted according to the thickness or dielectric constant of the second dielectric layer 123.

The first and second auxiliary electrodes 122a and 122b, respectively, are formed so as to be wider than the first and second sustaining electrodes 121a and 121b, respectively. The distance between the first auxiliary electrode 122a and the second auxiliary electrode 122b is smaller than that between the first sustaining electrode 121a and the second sustaining electrode 121b. The first and second sustaining electrodes 121a and 121b, respectively, and the first and second auxiliary electrodes 122a and 122b, respectively, may vary in width or position according to design conditions.

The first and second auxiliary electrodes 122a and 122b, respectively, are made of resistive materials. Preferably, the first and second auxiliary electrodes 122a and 122b, respectively, are made of a transparent resistive material, for example, ITO (Indium Tin Oxide) or SnO2, so as to cause the visible light emitted from the discharge cells 130 to be transmitted through the upper substrate 120. As described above, when the first and second auxiliary electrodes 122a and 122b, respectively, are made of resistive materials, the discharge path is substantially extended, as compared to the case when the first and second auxiliary electrodes 122a and 122b, respectively, are made of non-resistive materials, thereby improving luminous efficiency.

A protective layer 124 is formed on the bottom surface of the third dielectric layer 125. The protective layer 124 prevents the third dielectric layer 125 from being damaged due to sputtering of plasma particles, and reduces discharge voltage by emitting secondary electrons. The protective layer 124 is generally made of magnesium oxide (MgO).

In the above-described PDP, when external voltages are applied to the first and second sustaining electrodes 121a and 121b, respectively, predetermined voltages are induced in the first and second auxiliary electrodes 122a and 122b, respectively, resulting in a surface discharge in the space therebetween. In this case, the distance between the first auxiliary electrode 122a and the second auxiliary electrode 122b, where the surface discharge occurs, is smaller than that in a conventional PDP, thereby reducing discharge voltage. In addition, since the first and second auxiliary electrodes 122a and 122b, respectively, are made of resistive materials, the discharge path is extended during discharge, thereby enhancing luminous efficiency.

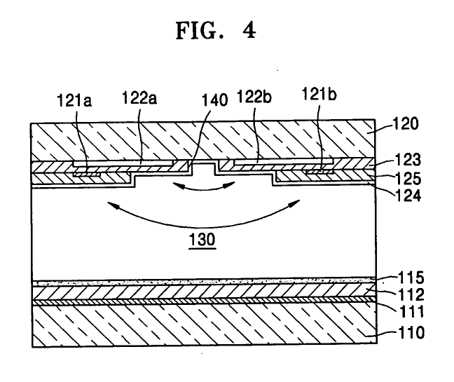

FIG. 4 is a cross-sectional view illustrating a variation of the PDP according to the first embodiment of the present invention.

Referring to FIG. 4, trenches 140 having a predetermined shape are formed in the second and third dielectric layers 123 and 125, respectively, disposed between the first auxiliary electrode 122a and the second auxiliary electrode 122b so as to be parallel to the first and second auxiliary electrodes 122a and 122b, respectively. When the trenches 140 are formed in the second and third dielectric layers 123 and 125, respectively, an electrical field is formed within the trenches 140, thereby further enhancing luminous efficiency.

The present invention is also applicable to a transmissive PDP, in addition to the reflective PDP discussed above.

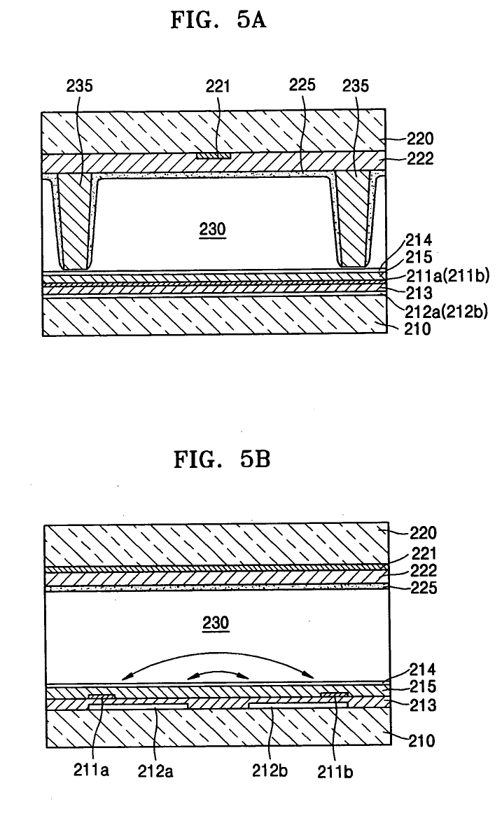

FIGS. 5A and 5B are cross-sectional views taken along horizontal and vertical directions of a PDP according to a second embodiment of the present invention.

The PDP of FIGS. 5A and 5B is a transmissive PDP in which a lower substrate 210 and an upper substrate 220 face each other with a discharge space formed therebetween. Multiple address electrodes 221 are formed on the bottom surface of the upper substrate 220, and the address electrodes 221 are covered by a first dielectric layer 222.

The address electrodes 221 are preferably made of a transparent conductive material so as to cause the visible light emitted during discharge to be transmitted through the upper substrate 220. The address electrodes 221 may also be formed on the lower substrate 210.

The discharge space is divided into multiple discharge cells 230 so as to form multiple barriers 235 on the bottom surface of the first dielectric layer 222. A phosphor layer 225 is coated on the top surface of the first dielectric layer 222 and lateral surfaces of the barriers 235, forming internal walls of the discharge cells 230 to a predetermined thickness.

First and second auxiliary electrodes 212a and 212b, respectively, are paired on the lower substrate 210 in each of the discharge cells 230, and the first and second auxiliary electrodes 212a and 212b, respectively, are covered by a second dielectric layer 213. In addition, first and second sustaining electrodes 211a and 211b, respectively, are paired on the second dielectric layer 213 in each of the discharge cells 230, and the first and second sustaining electrodes 211a and 211b, respectively, are covered by a third dielectric layer 215. Furthermore, a protective layer 214 is formed on the third dielectric layer 215.

As described above, the first and second sustaining electrodes 211a and 211b, respectively, are electrodes to which external voltages are applied, while the first and second auxiliary electrodes 212a and 212b, respectively, are floating electrodes to which voltages are induced as external voltages are applied to the first and second sustaining electrodes 211a and 211b, respectively. The first and second auxiliary electrodes 212a and 212b, respectively, are formed so as to be wider than the first and second sustaining electrodes 211a and 211b, respectively. The distance between the first auxiliary electrode 212a and the second auxiliary electrode 212b is smaller than that between the first sustaining electrode 211a and the second sustaining electrode 211b. The first and second auxiliary electrodes 212a and 212b, respectively, are made of resistive materials. The first and second auxiliary electrodes 212a and 212b, respectively, may also be made of ITO or SnO2. As described above, when the first and second auxiliary electrodes 212a and 212b, respectively, are made of resistive materials, the discharge path is substantially extended, compared to the case wherein the first and second auxiliary electrodes 212a and 212b, respectively, are made of non-resistive materials, thereby improving luminous efficiency.

Although not shown in FIGS. 5A and 5B, trenches having a predetermined shape may be formed in the second and third dielectric layers 213 and 215, respectively, disposed between the first auxiliary electrode 212a and the second auxiliary electrode 212b.

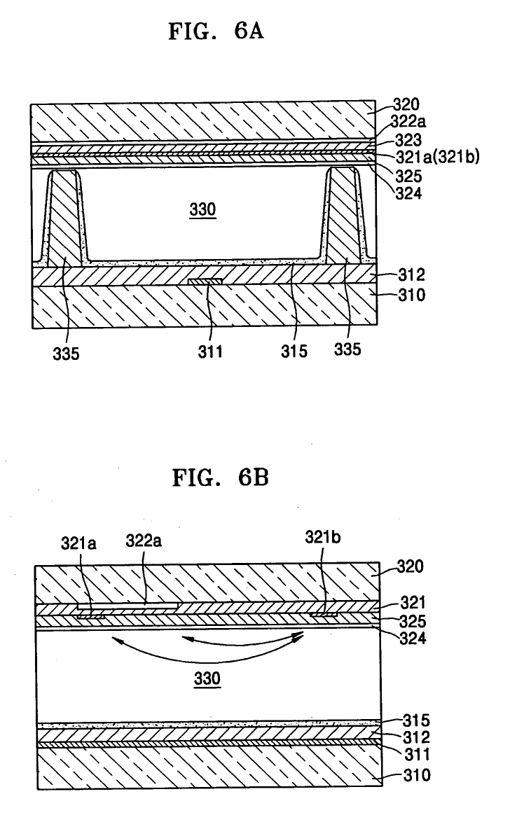

FIGS. 6A and 6B are cross-sectional views taken along horizontal and vertical directions of a PDP according to a third embodiment of the present invention.

The PDP of FIGS. 6A and 6B is a reflective PDP in which a lower substrate 310 and an upper substrate 320 are spaced apart by a predetermined interval and face each other with a discharge space formed therebetween. Multiple address electrodes 311 are formed on the lower substrate 320, and the address electrodes 311 are covered by a first dielectric layer 312. The discharge space is divided into the multiple discharge cells 330 so as to form multiple barriers 335 on the first dielectric layer 312. A phosphor layer 315 is coated on the top surface of the first dielectric layer 312 and lateral surfaces of the barriers 335, forming internal walls of the discharge cells 330 to a predetermined thickness. Although not shown in FIGS. 6A and 6B, a reflective layer for reflecting the visible light emitted from the discharge cells 330 toward the upper substrate 320 is formed on the lower substrate 310.

Auxiliary electrodes 322a are formed on the bottom surface of the upper substrate 320 in each of the discharge cells 330, and the auxiliary electrodes 322a are covered by a second dielectric layer 323. The auxiliary electrodes 322a are formed in a direction orthogonal to the address electrodes 311. First and second sustaining electrodes 321a and 321b, respectively, are paired on the bottom surface of the second dielectric layer 323 in each of the discharge cells 330, and the first and second sustaining electrodes 321a and 321b, respectively, are covered by a third dielectric layer 325. The first and second sustaining electrodes 321a and 321b, respectively, are formed in a direction orthogonal to the address electrode 311.

The first and second sustaining electrodes 321a and 321b, respectively, are electrodes to which external voltages are applied. The first sustaining electrode 321 a is an X electrode functioning as a display electrode, while the second sustaining electrode 321b is a Y electrode functioning as a scanning electrode. The first and second sustaining electrodes 321a and 321b, respectively, are generally made of a non-resistive, metallic material, e.g., Ag.

The auxiliary electrode 322a is formed so as to correspond to the first sustaining electrode 321a, i.e., the X electrode, and is a floating electrode to which a voltage is induced as an external voltage is applied to the first sustaining electrode 321a. The auxiliary electrode 322a is formed so as to correspond to the X electrode, that is, the first sustaining electrode 321a, of the first and second sustaining electrodes 321a and 321b, so as to avoid signal distortion. If the auxiliary electrode 322a is formed so as to correspond to the Y electrode, that is, the second sustaining electrode 321b, signal distortion may be generated during reset discharge and address discharge.

The auxiliary electrode 322a is formed so as to be wider than the first sustaining electrode 321a. The distance between the auxiliary electrode 322a and the second sustaining electrode 321b is smaller than that between the first sustaining electrode 321a and the second sustaining electrode 321b. The auxiliary electrode 322a is preferably made of a resistive material. In addition, the auxiliary electrode 322a is preferably made of a transparent resistive material, such as Indium Tin Oxide (ITO) or SnO2, so as to cause the visible light emitted from the discharge cells 330 to be transmitted through the upper substrate 320. The auxiliary electrode 322a may also be made of a metal, e.g., Ag.

A protective layer 324 is formed on the third dielectric layer 325. Although not shown in FIGS. 6A and 6B, trenches having a predetermined shape maybe formed in the second and third dielectric layers 323 and 325, respectively, disposed between the auxiliary electrode 322a and the second sustaining electrode 321b.

In the above-described PDP, when external voltages are applied to the first and second sustaining electrodes 321a and 321b, respectively, a predetermined voltage is induced in the auxiliary electrode 322a corresponding to the first sustaining electrode 321a. Accordingly, a discharge occurs first between the auxiliary electrode 322a and the second sustaining electrode 321b. In this case, since the distance between the auxiliary electrode 322a and the second sustaining electrode 321b, where discharge occurs, is smaller than that in a conventional PDP, the discharge voltage can be lowered. In addition, the discharge path can be extended during discharge, thereby enhancing luminous efficiency.

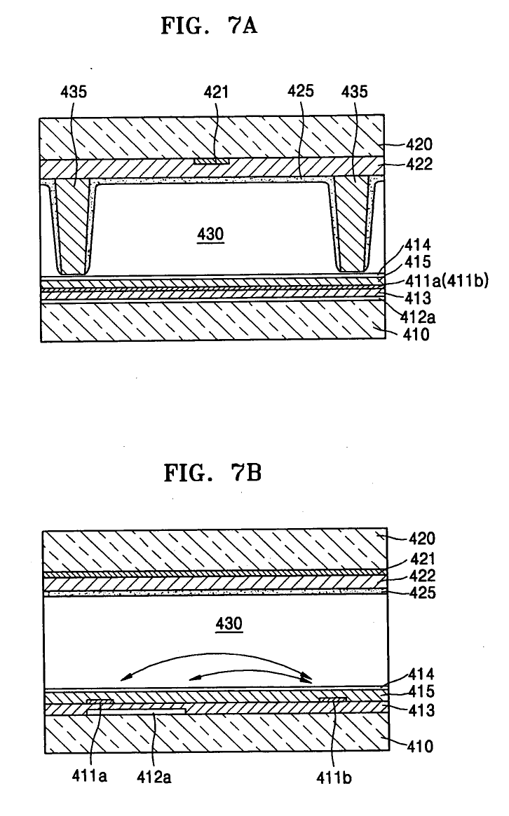

FIGS. 7A and 7B are cross-sectional views taken along horizontal and vertical directions of a PDP according to a fourth embodiment of the present invention.

The PDP of FIGS. 7A and 7B is a transmissive PDP in which a lower substrate 410 and an upper substrate 420 are spaced apart by a predetermined interval and face each other with a discharge space formed therebetween. Multiple address electrodes 421 are formed on the bottom surface of the upper substrate 420, and the address electrodes 421 are covered by a first dielectric layer 422. The address electrodes 421 are preferably made of a transparent conductive material. The address electrodes 421 may also be formed on the lower substrate 410.

The discharge space is divided into multiple discharge cells 430 on the first dielectric layer 422, and multiple barriers 435 are spaced apart by a predetermined gap. A phosphor layer 425 is excited by the UV light so as to emit visible light, and is coated on the bottom surface of the first dielectric layer 422 and lateral surfaces of the barriers 435, forming internal walls of the discharge cells 430 to a predetermined thickness.

Auxiliary electrodes 412a are formed on the top surface of the lower substrate 410 in each of the discharge cells 430, and the auxiliary electrodes 412a are covered by a second dielectric layer 413. First and second sustaining electrodes 411a and 411b, respectively, are paired on the top surface of the second dielectric layer 413 in each of the discharge cells 430, and the first and second sustaining electrodes 411a and 411b, respectively, are covered by a third dielectric layer 415. A protective layer 414 is formed on the third dielectric layer 415.

As described above, the first and second sustaining electrodes 411a and 411b, respectively, are electrodes to which external voltages are applied. The first sustaining electrode 411a is an X electrode functioning as a display electrode, while the second sustaining electrode 411b is a Y electrode functioning as a scanning electrode.

The auxiliary electrode 412a is formed so as to correspond to the first sustaining electrode 411a, i.e., the X electrode, and is a floating electrode to which a voltage is induced as an external voltage is induced in the first sustaining electrode 411a.

The auxiliary electrode 412a is formed so as to be wider than the first sustaining electrode 411a. The distance between the auxiliary electrode 412a and the second sustaining electrode 411b is smaller than that between the first sustaining electrode 411a and the second sustaining electrode 411b. The auxiliary electrode 412a is preferably made of a resistive material, and the auxiliary electrode 412a may also be made of a metal such as Ag.

Although not shown in FIGS. 7A and 7B, trenches having a predetermined shape may be formed in the second and third dielectric layers 413 and 415, respectively, disposed between the auxiliary electrode 412a and the second sustaining electrode 411b.

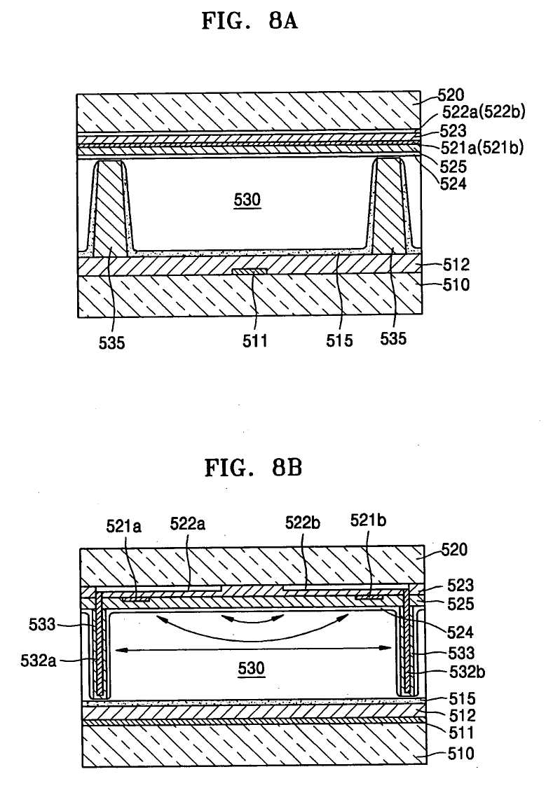

FIGS. 8A and 8B are cross-sectional views taken along horizontal and vertical directions of a PDP according to a fifth embodiment of the present invention.

The PDP of FIGS. 8A and 8B is a reflective PDP in which a lower substrate 510 and an upper substrate 520 are spaced apart by a predetermined interval and face each other with a discharge space formed therebetween. Multiple address electrodes 511 are formed on the lower substrate 520, and the address electrodes 511 are covered by a first dielectric layer 512. The discharge space is divided into the multiple discharge cells 530 so as to form multiple barriers 535 on the first dielectric layer 512. A phosphor layer 515 is coated on the top surface of the first dielectric layer 512 and lateral surfaces of the barriers 535, forming internal walls of the discharge cells 530 to a predetermined thickness. Although not shown in FIGS. 8A and 8B, a reflective layer for reflecting the visible light emitted from the discharge cells 530 toward the upper substrate 520 is formed on the lower substrate 510.

First and second auxiliary electrodes 522a and 522b, respectively, are paired on the bottom surface of the upper substrate 520 in each of the discharge cells 530, and the first and second auxiliary electrodes 522a and 522b, respectively, are covered by a second dielectric layer 523. The first and second auxiliary electrodes 522a and 522b, respectively, are formed in a direction orthogonal to the address electrodes 511. First and second sustaining electrodes 521a and 521b, respectively, are paired on the bottom surface of the second dielectric layer 523 in each of the discharge cells 530, and the first and second sustaining electrodes 521a and 521b, respectively, are covered by a third dielectric layer 525. The first and second sustaining electrodes 521a and 521b, respectively, are formed in a direction orthogonal to the address electrode 511.

The first and second sustaining electrodes 521a and 521b, respectively, are electrodes to which external voltages are applied. The first sustaining electrode 521a is an X electrode functioning as a display electrode, while the second sustaining electrode 521b is a Y electrode functioning as a scanning electrode. The first and second sustaining electrodes 521a and 521b, respectively, are generally made of a non-resistive, metallic material, e.g., Ag.

The first and second auxiliary electrodes 522a and 522b, respectively, are formed so as to correspond to the first and second sustaining electrodes 521a and 521b, respectively, and are floating electrodes to which voltages are induced as external voltages are applied to the first and second sustaining electrodes 521a and 521b, respectively.

The first and second auxiliary electrodes 522a and 522b, respectively, are formed so as to be wider than the first and second sustaining electrodes 521a and 521b, respectively. The distance between the first auxiliary electrode 522a and the second auxiliary electrode 522b is smaller than that between the first sustaining electrode 521a and the second sustaining electrode 521b.

The first and second auxiliary electrodes 522a and 522b, respectively, are preferably made of a resistive material. In addition, the first and second auxiliary electrodes 522a and 522b, respectively, are preferably made of a transparent resistive material such as ITO or SnO2 so as to cause the visible light emitted from the discharge cells 530 to be transmitted through the upper substrate 520. Although not shown in FIGS. 8A and 8B, trenches having a predetermined shape may be formed in the second and third dielectric layers 523 and 525, respectively, disposed between the first auxiliary electrode 522a and the second auxiliary electrode 522b.

Third and fourth auxiliary electrodes 532a and 532b, respectively, are paired between the lower substrate 510 and the upper substrate 520 so as to be opposite to and facing each other in each of the discharge cells 530. The third and fourth auxiliary electrodes 532a and 532b, respectively, are electrically connected to the first and second auxiliary electrodes 522a and 522b, respectively. The third and fourth auxiliary electrodes 532a and 532b, respectively, are covered by a fourth dielectric layer 533. A protective layer 524 is formed on a surface of the third and fourth dielectric layers 525 and 533, respectively.

In the above-described PDP, when external voltages are applied to the first and second sustaining electrodes 521a and 521b, respectively, predetermined voltages are induced in the first and second auxiliary electrodes 522a and 522b, respectively, so as to cause a surface discharge therebetween. Since the third and fourth auxiliary electrodes 532a and 532b, respectively, are electrically connected to the first and second auxiliary electrodes 522a and 522b, respectively, a facing discharge having an extended discharge path occurs between the third auxiliary electrode 532a and the fourth auxiliary electrode 532b, thereby further enhancing luminous efficiency compared to the luminous efficiencies of PDPs according to the previous embodiments.

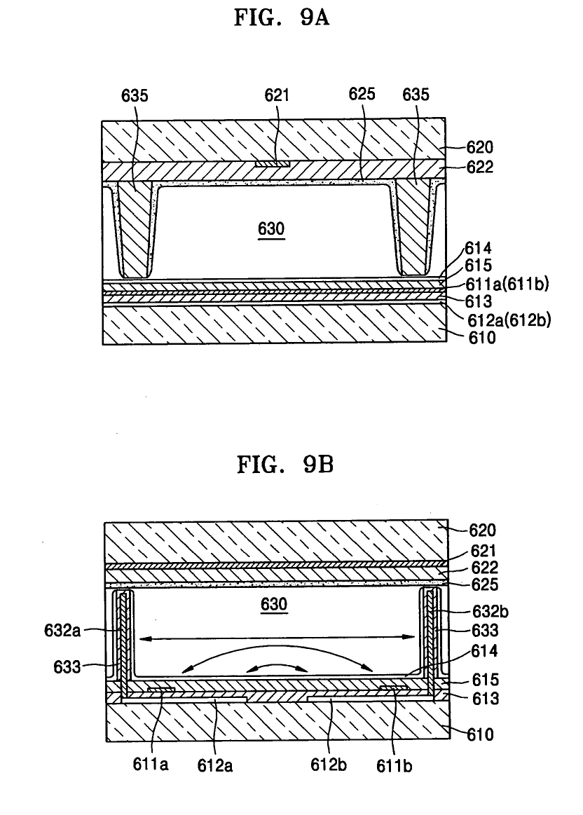

FIGS. 9A and 9B are cross-sectional views taken along horizontal and vertical directions of a PDP according to a sixth embodiment of the present invention.

The PDP of FIGS. 9A and 9B is a transmissive PDP in which a lower substrate 610 and an upper substrate 620 are spaced apart by a predetermined interval and face each other with a discharge space formed therebetween. Multiple address electrodes 621 are formed on the bottom surface of the upper substrate 620, and the address electrodes 621 are covered by a first dielectric layer 622. The address electrodes 621 are preferably made of a transparent conductive material. The address electrodes 621 may also be formed on the lower substrate 610.

The discharge space is divided into multiple discharge cells 630 on the first dielectric layer 622, and multiple barriers 635 are spaced apart by a predetermined gap. A phosphor layer 625 is coated on the bottom surface of the first dielectric layer 622 and lateral surfaces of the barriers 635, forming internal walls of the discharge cells 630 to a predetermined thickness.

First and second auxiliary electrodes 612a and 612b, respectively, are formed on the top surface of the lower substrate 610 in each of the discharge cells 630, and the first and second auxiliary electrodes 612a and 612b, respectively, are covered by a second dielectric layer 613. First and second sustaining electrodes 611a and 611b, respectively, are paired on the top surface of the second dielectric layer 613 in each of the discharge cells 630, and the first and second sustaining electrodes 611a and 611b, respectively, are covered by a third dielectric layer 615.

As described above, the first and second sustaining electrodes 611a and 611b, respectively, are electrodes to which external voltages are applied. The first and second auxiliary electrodes 612a and 612b, respectively, are floating electrodes in which voltages are induced as predetermined voltages are applied to the first and second sustaining electrodes 611a and 611b. The first and second auxiliary electrodes 612a and 612b, respectively, are formed so as to be wider than the first and second sustaining electrodes 611a and 611b, respectively. The distance between the first auxiliary electrode 612a and the second auxiliary electrode 612b is smaller than that between the first sustaining electrode 611a and the second sustaining electrode 611b. The first and second auxiliary electrodes 612a and 612b, respectively, are preferably made of a resistive material, but the first and second auxiliary electrodes 612a and 612b, respectively, may also be made of a metal, e.g., Ag. Although not shown in FIGS. 9A and 9B, trenches having a predetermined shape may be formed in the second and third dielectric layers 613 and 615, respectively, disposed between the first auxiliary electrode 612a and the second auxiliary electrode 612b.

Third and fourth auxiliary electrodes 632a and 632b, respectively, are paired between the lower substrate 610 and the upper substrate 620 so as to be opposite to and facing each other in each of the discharge cells 630. The third and fourth auxiliary electrodes 632a and 632b, respectively, are electrically connected to the first and second auxiliary electrodes 612a and 612b, respectively. The third and fourth auxiliary electrodes 632a and 632b, respectively, are covered by a fourth dielectric layer 633. A protective layer 614 is formed on a surface of the third and fourth dielectric layers 615 and 633, respectively.

While the above-described embodiments have been described as including auxiliary electrodes in which voltages are induced as external voltages are applied to sustaining electrodes, and which are formed outside sustaining electrodes, the invention is not limited thereto, and the auxiliary electrodes may also be formed inside the sustaining electrodes.

As described above, in the PDP according to the present invention, auxiliary electrodes, to which voltages are induced as external voltages are applied to sustaining electrodes, are provided on an upper substrate or a lower substrate, thereby reducing discharge voltage and enhancing luminous efficiency of the PDP.

While the present invention has been particularly shown and described with reference to exemplary embodiments thereof, it will be understood by those of ordinary skill in the art that various changes in form and detail may be made therein without departing from the spirit and scope of the present invention as defined by the following claims.

What is claimed is:

1. A plasma display panel, comprising:
a lower substrate and an upper substrate facing each other, spaced apart from each other by a predetermined gap, and forming a discharge space therebetween;
barriers provided between the lower substrate and the upper substrate, the barriers being formed by dividing the discharge space so as to define a plurality of discharge cells;
address electrodes formed on the lower substrate;
a first dielectric layer covering the address electrodes;
a phosphor layer formed on an internal wall of each of the discharge cells;
first and second sustaining electrodes formed in pairs on the upper substrate in each of the discharge cells; and
first and second auxiliary electrodes which are formed on the upper substrate so as to correspond to the first and second sustaining electrodes, and in which predetermined voltages are induced as external voltages are applied the first and second sustaining electrodes, wherein the first and second auxiliary electrodes are made of a resistive material.

2. The plasma display panel of claim 1, wherein the first and second auxiliary electrodes are formed on upper portions of the first and second sustaining electrodes.

3. The plasma display panel of claim 2, wherein a distance between the first auxiliary electrode and the second auxiliary electrode is smaller than a distance between the first sustaining electrode and the second sustaining electrode.

4. The plasma display panel of claim 3, further comprising a second dielectric layer formed between the first and second auxiliary electrodes and the first and second sustaining electrodes, a third dielectric layer formed on the second dielectric layer so as to cover the first and second sustaining electrodes, and a protective layer formed on a surface of the third dielectric layer.

5. The plasma display panel of claim 4, wherein trenches are formed in the second and third dielectric layers and disposed between the first auxiliary electrode and the second auxiliary electrode.

6. The plasma display panel of claim 1, wherein the first and second auxiliary electrodes are made of a transparent resistive material.

7. The plasma display panel of claim 6, wherein the first and second auxiliary electrodes are made of Indium Tin Oxide (ITO) or SnO₂.

8. A plasma display panel, comprising:
a lower substrate and an upper substrate facing each other, spaced apart from each other by a predetermined gap and forming a discharge space therebetween;
barriers provided between the lower substrate and the upper substrate, the barriers being formed by dividing the discharge space so as to define a plurality of discharge cells;
address electrodes formed on one of the lower substrate and the upper substrate;
a first dielectric layer covering the address electrodes;
a phosphor layer formed on an internal wall of each of the discharge cells;
first and second sustaining electrodes formed in pairs on the lower substrate in each of the discharge cells; and
first and second auxiliary electrodes which are formed on the lower substrate so as to correspond to the first and second sustaining electrodes, and in which voltages are induced as the voltages are applied the first and second sustaining electrodes, wherein the first and second auxiliary electrodes are made of a resistive material.

9. The plasma display panel of claim 8, wherein the first and second auxiliary electrodes are formed under the first and second sustaining electrodes.

10. The plasma display panel of claim 9, wherein a distance between the first auxiliary electrode and the second auxiliary electrode is smaller than a distance the first sustaining electrode and the second sustaining electrode.

11. The plasma display panel of claim 10, further comprising a second dielectric layer formed between the first and second auxiliary electrodes and the first and second sustaining electrodes, a third dielectric layer formed on the second dielectric layer so as to cover the first and second sustaining electrodes, and a protective layer formed on a surface of the third dielectric layer.

12. The plasma display panel of claim 11, wherein trenches are formed in the second and third dielectric layers and disposed between the first auxiliary electrode and the second auxiliary electrode.

13. A plasma display panel, comprising:
a lower substrate and an upper substrate facing each other, spaced apart from each other by a predetermined gap, and forming a discharge space therebetween;
barriers provided between the lower substrate and the upper substrate, the barriers being formed by dividing the discharge space so as to define a plurality of discharge cells;
address electrodes formed on the lower substrate;
a first dielectric layer covering the address electrodes;
a phosphor layer formed on an internal wall of each of the discharge cells;
first and second sustaining electrodes formed in pairs on the upper substrate in each of the discharge cells; and
an auxiliary electrode which is formed on the upper substrate so as to correspond to the first sustaining electrode, and in which a voltage is induced as the voltage is applied the first sustaining electrode.

14. The plasma display panel of claim 13, wherein the first sustaining electrode is a display electrode and the second sustaining electrode is a scanning electrode.

15. The plasma display panel of claim 14, wherein the auxiliary electrode is formed on an upper portion of the first sustaining electrode.

16. The plasma display panel of claim 15, wherein a distance between the auxiliary electrode and the second sustaining electrode is smaller than a distance between the first sustaining electrode and the second sustaining electrode.

17. The plasma display panel of claim 16, further comprising a second dielectric layer formed between the auxiliary electrode and the first and second sustaining electrodes, a third dielectric layer formed on the second dielectric layer so as to cover the first and second sustaining electrodes, and a protective layer formed on a surface of the third dielectric layer.

18. The plasma display panel of claim 17, wherein trenches are formed in the second and third dielectric layers and disposed between the auxiliary electrode and the second sustaining electrode.

19. The plasma display panel of claim 13, wherein the auxiliary electrode is made of one of a resistive material and metal.

20. The plasma display panel of claim 19, wherein the auxiliary electrode is made of a transparent resistive material.

21. A plasma display panel, comprising:
a lower substrate and an upper substrate spaced apart from each other by a predetermined interval and facing each other with a discharge space formed therebetween;
barriers provided between the lower substrate and the upper substrate, the barriers being formed by dividing the discharge space so as to define a plurality of discharge cells;
address electrodes formed on one of the lower substrate and the lower substrate;
a first dielectric layer covering the address electrodes;
a phosphor layer formed on an internal wall of each of the discharge cells;
first and second sustaining electrodes formed in pairs on the lower substrate in each of the discharge cells; and
an auxiliary electrode which is formed on the lower substrate so as to correspond to the first sustaining electrode, and in which a voltage is induced as an external voltage is applied the first sustaining electrode.

22. The plasma display panel of claim 21, wherein the first sustaining electrode is a display electrode and the second sustaining electrode is a scanning electrode.

23. The plasma display panel of claim 22, wherein the auxiliary electrode is formed under the first sustaining electrode.

24. The plasma display panel of claim 23, wherein a distance between the auxiliary electrode and the second sustaining electrode is smaller than a distance between the first sustaining electrode and the second sustaining electrode.

25. The plasma display panel of claim 24, further comprising a second dielectric layer formed between the auxiliary electrode and the first and second sustaining electrodes, a third dielectric layer formed on the second dielectric layer so as to cover the first and second sustaining electrodes, and a protective layer formed on a surface of the third dielectric layer.

26. The plasma display panel of claim 25, wherein trenches are formed in the second and third dielectric layers and disposed between the auxiliary electrode and the second sustaining electrode.

27. The plasma display panel of claim 21, wherein the auxiliary electrode is made of one of a resistive material and metal.

28. A plasma display panel, comprising:
a lower substrate and an upper substrate spaced apart from each other by a predetermined interval and facing each other with a discharge space formed therebetween;
barriers provided between the lower substrate and the upper substrate, the barriers being formed by dividing the discharge space so as to define a plurality of discharge cells;
address electrodes formed on the lower substrate;
a first dielectric layer covering the address electrodes;
a phosphor layer formed on an internal wall of each of the discharge cells;
first and second sustaining electrodes formed in pairs on the upper substrate in each of the discharge cells;
first and second auxiliary electrodes which are formed on the upper substrate so as to correspond to the first and second sustaining electrodes, and in which voltages are induced as external voltages are applied to the first and second sustaining electrodes; and
third and fourth auxiliary electrodes which are paired between the lower and upper substrates so as to be opposite to and facing each other, and which are electrically connected to the first and second auxiliary electrodes, respectively.

29. The plasma display panel of claim 28, wherein the first and second auxiliary electrodes are formed on upper portions of the first and second sustaining electrodes.

30. The plasma display panel of claim 29, wherein an interval between the first auxiliary electrode and the second auxiliary electrode is smaller than an interval between the first sustaining electrode and the second sustaining electrode.

31. The plasma display panel of claim 30, further comprising a second dielectric layer formed between the first and second auxiliary electrodes and the first and second sustaining electrodes, a third dielectric layer formed on the second dielectric layer so as to cover the first and second sustaining electrodes, and a protective layer formed on the third dielectric layer.

32. The plasma display panel of claim 31, further comprising a fourth dielectric layer formed on the third and fourth auxiliary electrodes, and wherein the protective layer is formed on the fourth dielectric layer.

33. The plasma display panel of claim 31, wherein trenches are formed in the second and third dielectric layers and disposed between the first auxiliary electrode and the second auxiliary electrode.

34. The plasma display panel of claim 28, wherein the first and second auxiliary electrodes are made of one of a resistive material and a metal.

35. The plasma display panel of claim 34, wherein the first and second auxiliary electrodes are made of a transparent resistive material.

36. A plasma display panel, comprising:
a lower substrate and an upper substrate spaced apart from each other by a predetermined interval and facing each other with a discharge space formed therebetween;
barriers provided between the lower substrate and the upper substrate, the barriers being formed by dividing the discharge space so as to define a plurality of discharge cells;
address electrodes formed on one of the lower substrate and the upper substrate;
a first dielectric layer covering the address electrodes;
a phosphor layer formed on an internal wall of each of the discharge cells;
first and second sustaining electrodes formed in pairs on the lower substrate in each of the discharge cells;
first and second auxiliary electrodes which are formed on the lower substrate so as to correspond to the first and second sustaining electrodes, and in which voltages are induced as external voltages are applied to the first and second sustaining electrodes; and
third and fourth auxiliary electrodes which are paired between the lower and upper substrates so as to be opposite to and facing each other, and which are electrically connected to the first and second auxiliary electrodes, respectively.

37. The plasma display panel of claim 36, wherein the first and second auxiliary electrodes are formed under the first and second sustaining electrodes.

38. The plasma display panel of claim 37, wherein a distance between the first auxiliary electrode and the second auxiliary electrode is smaller than a distance between the first sustaining electrode and the second sustaining electrode.

39. The plasma display panel of claim 30, further comprising a second dielectric layer formed between the first and second auxiliary electrodes and the first and second sustaining electrodes, a third dielectric layer formed on the second dielectric layer so as to cover the first and second sustaining electrodes, and a protective layer formed on the third dielectric layer.

40. The plasma display panel of claim 39, further comprising a fourth dielectric layer formed on the third and fourth auxiliary electrodes, and wherein the protective layer is formed on the fourth dielectric layer.

41. The plasma display panel of claim 39, wherein trenches are formed in the second and third dielectric layers and disposed between the first auxiliary electrode and the second auxiliary electrode.

42. The plasma display panel of claim 36, wherein the first and second auxiliary electrodes are made of one of a resistive material and a metal.
